(19) United States
(12) Patent Application Publication
(10) Pub. No.: US 2010/0277773 A1
(43) Pub. Date: Nov. 4, 2010

(54) Penta-mirror multi-reflection scanning module

(75) Inventors: Ai-Lien Lai, Taipei (TW); Ching-Yuan Lin, Taipei (TW); San-Woei Shyu, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: E-PIN OPTICAL INDUSTRY CO., LTD., Taipei (TW)

(21) Appl. No.: 12/554,426

(22) Filed: Sep. 4, 2009

(30) Foreign Application Priority Data
Apr. 30, 2009 (TW) 098114538

(51) Int. Cl. H04N 1/04

(52) U.S. Cl. 358/474

(57) ABSTRACT

The present invention discloses a penta-mirror multi-reflection image scanning module including at least one light source, five reflecting mirrors, a pickup lens, an image sensor, and a frame. The reflecting mirrors reflect a light beam from a document and a plurality of reflecting mirrors reflect a light beam of the document twice or more to change the light beam direction along light path, and satisfy specific optical conditions. The total tracking length (TTL) may be adjusted through an arrangement of the distance of the five reflecting mirrors, but may not be adjusted through the angle of the five reflecting mirrors. Therefore, the present invention not only increases the field of depth by increasing the length of optical path in a limited space, but also facilitates the assembling to adapt to different tracking lengths.

### BACKGROUND OF THE INVENTION

1. Field of the Invention

The present invention relates to a penta-mirror multi-reflection scanning module for a scanned light beam, in particular to an image scanning module having five reflecting mirrors applied to related equipments such as flatbed scanners or multi-function printers.

2. Description of the Related Art

In recent years, scanner, particularly image scanner, becomes a major computer peripheral product, and the image scanner may capture an image of an object such as a document, a textual page, a photo, a film or even a flat object. The image may be captured by a way of projecting a light onto the document first, such that the light reflected by the document forms an image beam, and then using a plurality of reflection mirrors to reflect and change its optical path, and finally the image beam is focused at the image sensor by the pickup lens for sensing the image. Since the content of the document is generally composed of texts or graphics, areas with different brightness will be formed. Thus, the reflected image beams have different intensities as the projecting positions of the reflected image beams vary. If the image beam is focused at a charge-coupled device, (CCD) image sensor or a complementary metal oxide semiconductor (CMOS) image sensor, a sensing element converts the focused image beam into a corresponding photoelectric signal, and then a scanning software program reads data, and finally a digital image is formed. The scanned image may be stored into a magnetic device (such as a hard disk) or an optical device (such as an optical disk). Standard and common images are stored in a tagged image file format (TIFF), an encapsulated postscript (EPS) format, a bitmap image file format (BMP), a graphics interchange format (GIF) and a PC paintbrush exchange (PCX) format, etc. A commercial scanner such as a flat-bed scanner is used for scanning photos or printed matters. The scanner includes a cover glass disposed thereon for placing a desired scanning document, and a scanning module is moved by a rail to scan the document sequentially column by column, and convert the images into digital data, and this is a common scanner. Related equipments of a scanner manufactured by a similar principle such as multi-function printers scan an image by moving the document with respect to the scanning module.

With reference to FIGS. 1 to 3 for schematic views of structures and optical path arrangements of different conventional scanning modules respectively, the image scanning module 91 includes a cover glass 12, a frame 13, an image sensor 14, a pickup lens 15, a light source 16 and reflection mirrors 917. The light source 16 emits a light to be projected onto a desired scanning document 2 to form an image beam, and different ways of arranging the reflection mirrors 917 are adopted for changing the direction and path of the image beam, such that the image beam is incident into the pickup lens 15 and the image sensor 14. As the user's requirements and related manufacturing technologies advance, the image scanning module 91 becomes increasingly thinner, shorter and more compact, and thus the volume and internal space for disposing components of the image scanning module 91 become smaller and smaller. As to the pickup lens 15 and the image sensor 14 having the same resolution, a plurality of reflecting mirrors may be disposed in the limited space of the image scanning module 91, such that a scanning light may be reflected for several times before entering into the image scanning module to increase the optical path and the depth of field. Although this method may scan non-flat document 2 such as a wrinkled document to obtain a better image, yet the image beam reflected from the document may produce an overlapped light beam. After the image beam is reflected for several times, the image beam may enter into the pickup lens 15, and the image may be overlapped with the original image to form a ghost image. Different solutions were disclosed in U.S. Pat. No. 5,815,329, U.S. Pat. No. 6,170,651, U.S. Pat. No. 6,421,158, U.S. Pat. No. 6,227,449, US2008/0007810 and US2008/0170268; JP. No. 6006524, 2005-328187 and 2004-274299; GB. Pat. No. 2317293; and TW Pat. No. 476494, etc. In FIG. 1, four reflecting mirrors 917 are used, and each reflecting mirror 917 reflects the image beam once. In FIG. 2, three reflecting mirrors 917 are used, wherein two of the three reflecting mirrors 917 reflect the image beam twice. In FIG. 3, five reflecting mirrors 917 are used, and one of the five reflecting mirrors 917 reflects the image beam twice. No reflecting matter is disposed between the reflecting mirrors to avoid the reflection of the overlapped light beam. Alternatively, a prior art as disclosed by U.S. Pat. No. US2008/0084625 restricts the angle of the first reflecting mirror in order to prevent the overlapped light beam from entering into a long and wide reflecting mirror.

In the prior art, if a pickup lens of a different effective focal length (EFL) causes a change of the total tracking length (TTL) or an image scanning module is applied to a different branded scanner, or the scanning size of a scanner is changed, such as a scanner of A4/A3 size, it is necessary to rearrange the distances as well as angles of each reflecting mirror. However, it is necessary to adjust the angle and position of each reflecting mirror in the limited space, such that the image beam may be focused by the pickup lens. In addition, it is necessary to adjust the angle and position of each reflecting mirror in the limited space to reduce the ghost image phenomenon. To widely use scanning modules with the aforementioned conditions, the prior art rearranges the angle and the position of the reflecting mirrors, or even changes the optical path of the reflecting mirrors. This adjusting method will require another mold for the manufacture of the frame, and thus will incur a higher manufacturing cost. During assembling, the angles of reflection of most reflecting mirrors satisfy the optical path to eliminate the ghost image and require an adjustment, so that it is difficult to lower the assembling cost. Furthermore, the application will be restricted and inconvenient. Therefore, an image scanning module with a minimal adjustment of the reflecting mirrors may be developed easily and simply to meet the urgent needs for different branded scanners, scanners of A4/A3 sizes, or pickup lenses with different effective focal length and total tracking length (TTL), etc.

### SUMMARY OF THE INVENTION

In view of the aforementioned shortcomings of the prior art, the present invention provides a multi-reflection image scanning module having five reflecting mirrors to increase the depth of field and overcomes the applicability issue of the prior art.

To achieve the foregoing objectives, the present invention provides an image scanning module having five reflecting mirrors for multi-reflections in accordance with the present invention, and an image of a scanning document is reflected by the five reflecting mirrors to change its direction and path and increase its optical tracking length, and an angle of the five reflecting mirrors is arranged to prevent an overlapped light beam from entering into a pickup lens so as to reduce a ghost image phenomenon. The image scanning module having five reflecting mirrors for multi-reflections in accordance with the present invention comprises at least one light source, five reflecting mirrors, a pickup lens, an image sensor and a frame, wherein at least two of the five reflecting mirrors have two or more times of multi-reflections, and its optical path is Li(Obj)→M1→M2→M3→M4→M3→M2→M5→Lo(Img), and satisfies the optical conditions of:

$$\begin{matrix}0.7 \leq \frac{{D}_{refl}}{2 ( TTL - {D}_{refl} )} \leq 1.0 ; & ( 1 ) \\ - \frac{1}{2} \cdot \frac{π}{( p + 1 )} \leq {\sum }_{i = 1}^{p} {α}_{i} - \frac{π}{2} ( p + 1 ) \leq \frac{1}{2} \cdot \frac{π}{( p + 1 )} ; & ( 2 )\end{matrix}$$

where, p is the total numbers of reflections along the optical path; TTL is the total tracking length TTL=Dᵢ+D₁+D₂+D₃+D₄+D₅+D₆+D_{O}; D_{refl} is the total between reflecting mirrors and D_{refl}=D₁+D₂+D₃+D₄+D₅+D₆; and αᵢ is an inclined angle between the normal line of a reflecting plane of the i^{th} reflecting mirror along the optical path and the +Z-axis.

Therefore, the penta-mirror multi-reflection scanning module in accordance with the present invention has one or more of the following advantages:

(1) The five reflecting mirrors reflect the image beam, and at least two of the five reflecting mirrors have multi-reflections to increase the total tracking length. The position and angle of the reflecting mirrors are arranged to reduce or eliminate the overlapped light beam produced by multi-reflections of the reflecting mirrors, so as to reduce the ghost image phenomenon.

(2) The position of the reflecting mirrors may be adjusted by the optical path of five reflecting mirrors to adapt to different total tracking lengths of scanners with different sizes such as A4/A3 sizes, or pickup lenses with different effective focal lengths. Users simply adjust the relative position of the reflecting mirrors to project the image beam Lo into the pickup lens along the optical axis of the pickup lens to provide a broader scope of applications.

(3) With the matched effective focal length and total tracking length of the pickup lens, the position of the reflecting mirrors may be adjusted to minimize the volume of the frame, so as to achieve a compact design requirement.

### BRIEF DESCRIPTION OF THE DRAWINGS

FIG. 1 is a schematic view of a first conventional image scanning module;

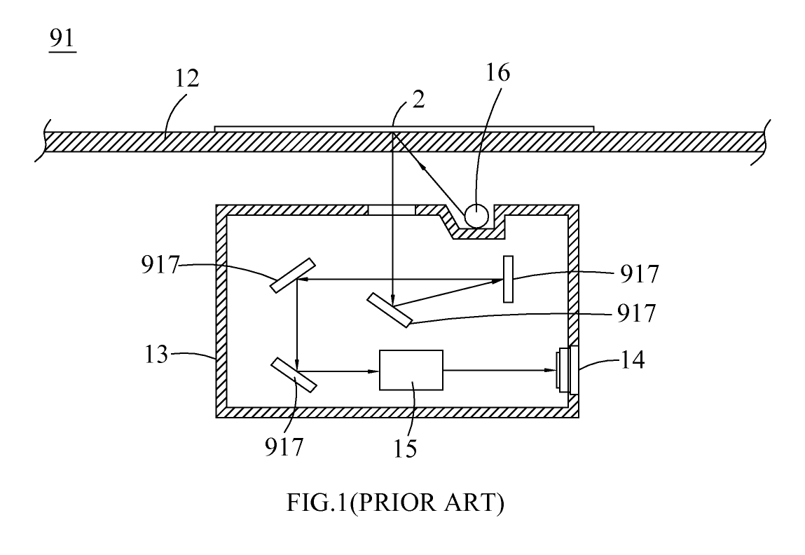

FIG. 2 is a schematic view of a second conventional image scanning module;

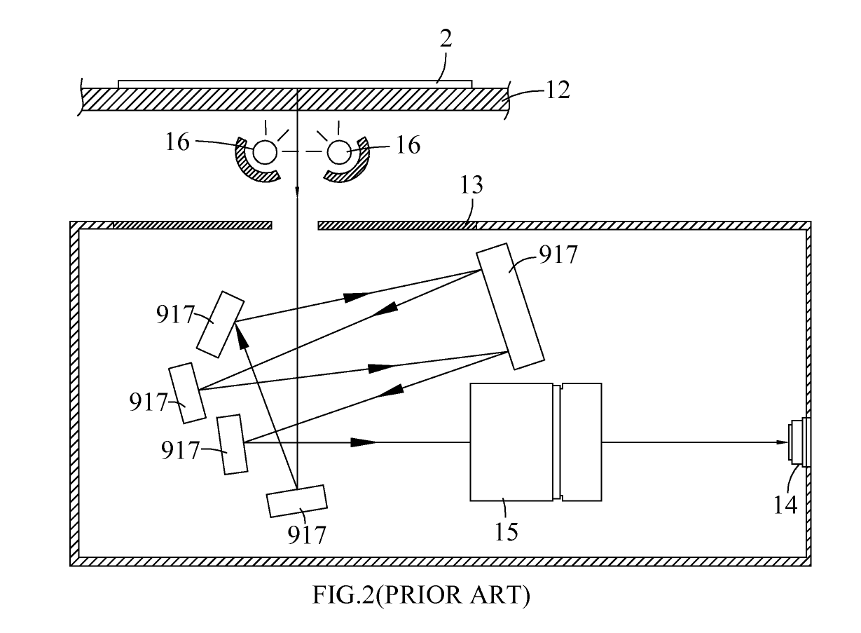

FIG. 3 is a schematic view of a third conventional image scanning module;

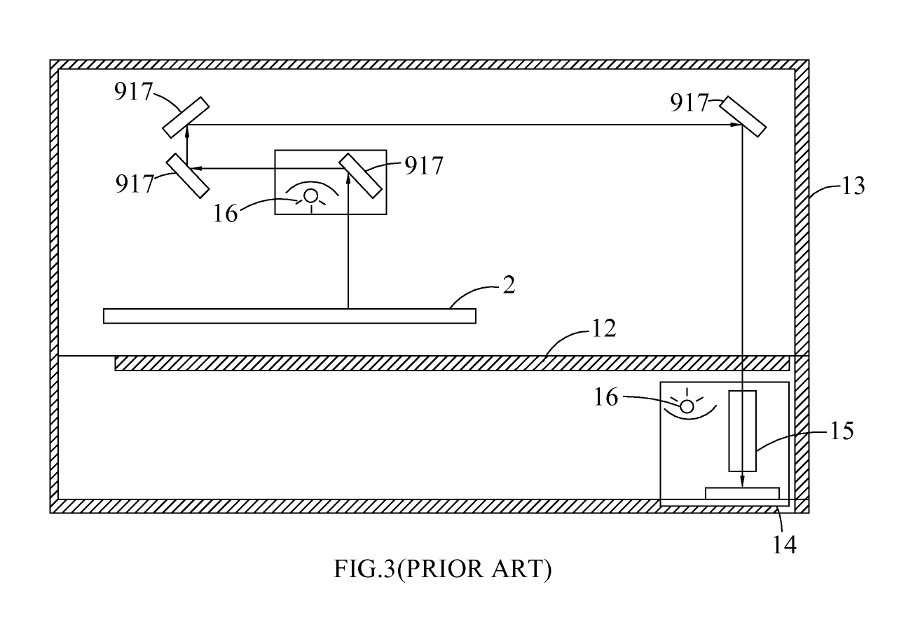

FIG. 4 is a schematic view of an image scanning module having five reflecting mirrors in accordance with the present invention;

FIG. 5 is a schematic view of a reflecting angle of an image scanning module having five reflecting mirrors in accordance with the present invention;

FIG. 6 is a schematic view of eliminating an overlapped light beam on an optical path M2→M3 of an image scanning module having five reflecting mirrors in accordance with the present invention;

FIG. 7 is a schematic view of an image scanning module having five reflecting mirrors in accordance with a second preferred embodiment of the present invention;

FIG. 8 is a schematic view of an image scanning module having five reflecting mirrors in accordance with a third preferred embodiment of the present invention; and

FIG. 9 is a schematic view of an image scanning module having five reflecting mirrors in accordance with a fourth preferred embodiment of the present invention.

### DETAILED DESCRIPTION OF THE PREFERRED EMBODIMENTS

The technical characteristics of an image scanning module thereof in accordance with the present invention will become apparent from the following detailed description taken with the accompanying drawings.

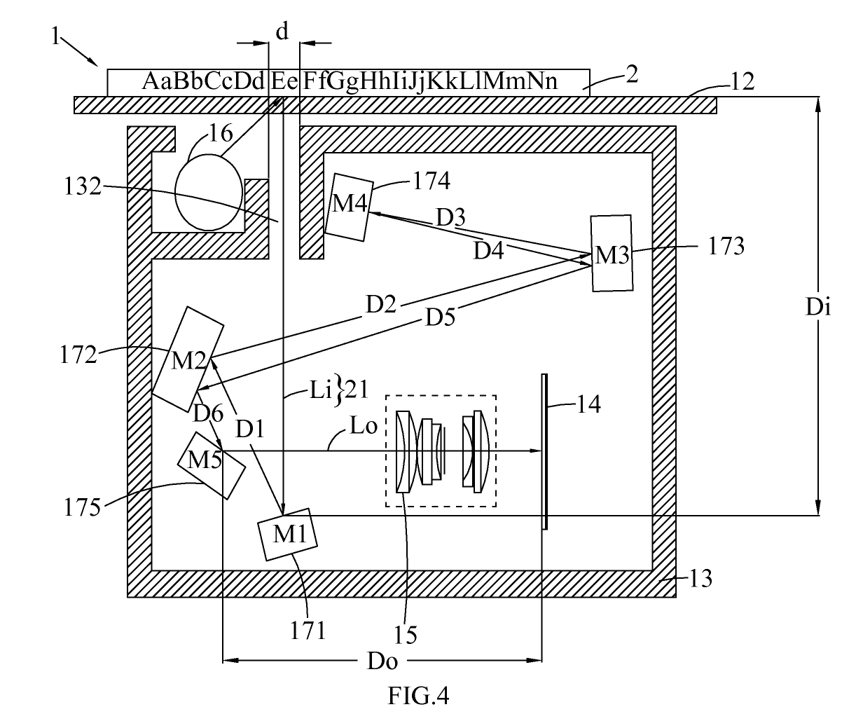

With reference to FIG. 4 for an image scanning module 1 having five reflecting mirrors for multi-reflection, the image scanning module 1 comprises a light source 16, five reflecting mirrors (M1, M2, M3, M4, M5) 171˜175, a pickup lens 15, an image sensor 14 and a frame 13. After the light source 16 emits a light, the light passes through the cover glass 12 and is projected onto a scanning document 2. The scanning document 2 reflects the light to form a reflected light. After the reflected light passes through the cover glass 12 to form an image beam Li 21 incident at the image scanning module 1. After the image beam Li 21 is incident at a first reflecting mirror (M1)171 to give a first reflection, the reflected image beam is incident at a second reflecting mirror (M2)172 to give a second reflection. The reflected image beam is incident at the third reflecting mirror (M3)173 to give a third reflection, and then reflecting at a fourth reflecting mirror (M4)174 to give a fourth reflection, and then reflecting at the third reflecting mirror (M3)173 to give a fifth reflection, and then reflecting at the second reflecting mirror (M2)172 to give a sixth reflection, and then reflecting at the fifth reflecting mirror (M5)175 to give a seventh reflection, and finally an image beam Lo incident at the pickup lens 15 is formed. The optical path is Li (Obj, document)→M1→M2→M3→M4→M3→M2→M5→Lo (Img, image sensor); wherein the second reflecting mirror (M2)172 and third reflecting mirror (M3)173 have multi-reflection, and each of the second and third mirror undergoes a reflection twice.

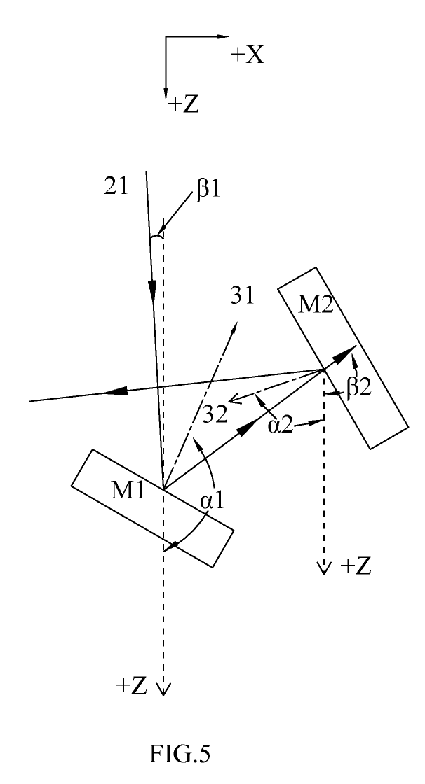

The present invention provides an image scanning module having five reflecting mirrors for multi-reflection as shown in FIG. 4, and the image scanning module comprises at least one light source, five reflecting mirrors, a pickup lens, an image sensor and a frame. On the X-Z plane, one half of the total distance between the reflecting mirrors and the total tracking length (TTL) satisfy the condition of:

$$0.7 \leq \frac{{D}_{refl}}{2 ( TTL - {D}_{refl} )} \leq 1.0 ;$$

where, TTL is the total tracking length TTL=Dᵢ+D₁+D₂+D₃+D₄+D₅+D₆ +D_{O}; D_{refl} is the total distance between the reflecting mirrors along the optical path, and D_{refl}=D₁+D₂+D₃+D₄+D₅+D₆ as shown in FIG. 4; and the angle between the mirrors satisfies the condition of:

$$- \frac{π}{( p + 1 )} \leq {\sum }_{i = 1}^{p} {α}_{i} - \frac{π}{2} ( p + 1 ) \leq \frac{π}{( p + 1 )} ;$$

where αᵢ is an inclined angle (rad.) between the normal line of a reflecting plane of an i^{th} reflecting mirror on the optical path and the +Z-axis, and the symbols are illustrated in FIG. 5, and p is the total number of reflection times along the optical path, and p=7 as shown in FIG. 4,

$${\sum }_{i = 1}^{p} {α}_{i} - \frac{π}{2} ( p + 1 ) = ( \begin{matrix}{α}_{1} + {α}_{2} + {α}_{3} + {α}_{4} + \\ {α}_{3} + {α}_{2} + {α}_{5}\end{matrix} ) - \frac{π}{2} ( 7 + 1 ) ; \qquad ( 3 )$$

In a positional relation of the reflecting mirrors, the coordinates (M_{kX}, M_{kZ}) of a reflecting point, an angle of a reflecting mirror and an angle of light incident at a reflecting mirror light of the previous reflecting mirror are determined by:

M_{(k+1)X}=M_{kX}−Dₖ sin(180±(2αₖ+βₖ)) M_{(k+1)Z}=M_{kZ}−Dₖ Cos(180±(2αₖ+βₖ)); (4)

where (M_{kX}, M_{kZ}) is the (X,Z) coordinates of a reflecting point of the k^{th} reflecting mirror, and βᵢ is an inclined angle(rad.) between the image beam incident at the k^{th} reflecting mirror and the +Z-axis, as illustrated in FIG. 5.

To effectively reduce the volume of the frame while maintaining the total tracking length unchanged, the reflecting mirror of the present invention undergo multi-reflection, wherein the reflecting mirror (M2) 172 reflects the image beam twice, and the reflecting mirror (M3) 173 reflects the image beam twice. In the prior art, the same reflecting mirror undergoing multi-reflection will produce a serious overlapped light beam to give a ghost image phenomenon, and it is necessary to dispose or adjust the width and the angle of the reflecting mirrors appropriately to reduce the overlapped light beam. However, the image scanning module having five reflecting mirrors in accordance with the present invention adopts a longer tracking length of the optical path M2→M3 and M3→M2 of a reflecting mirror having multi-reflection, and a shorter tracking length at the reflecting point of the reflecting mirror having multi-reflection, so as to reduce the overlapped light beam effectively.

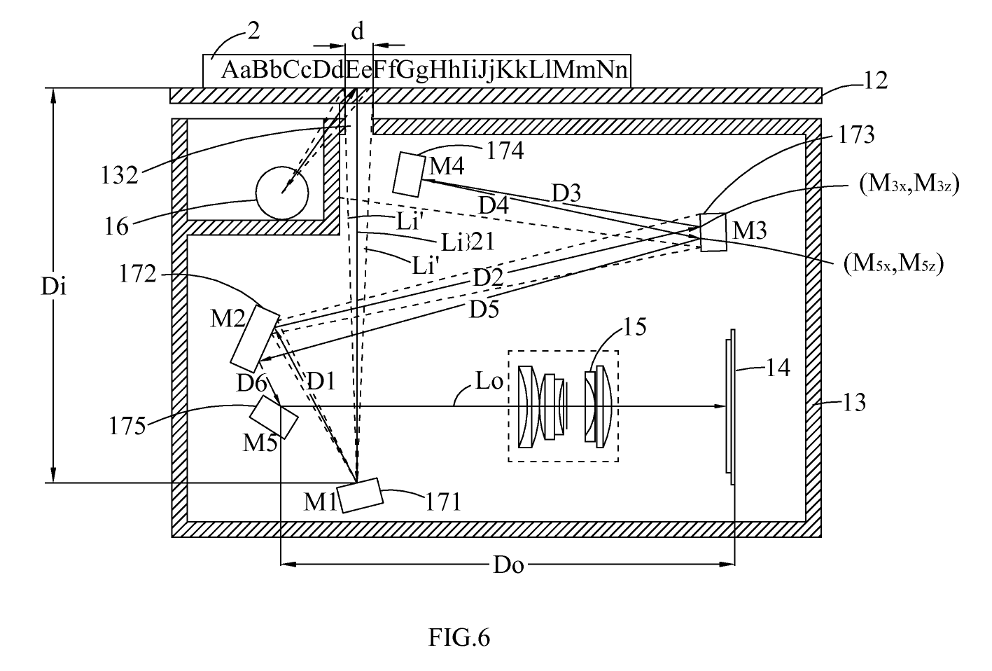

In FIG. 6, after the light source 16 emits a light, the light passes through the cover glass 12 and is projected onto a scanning document 2. The light projected onto the scanning document 2 is reflected and passed through the cover glass 12 to form an image beam Li 21 incident at the image scanning module 1. The image beam Li′ passing through an aperture 132 on the frame is an overlapped light beam, and the image beam Li′ is reflected from the first reflecting mirror (M1)171 for a first reflection, and then the reflected light of the image beam Li produces a reflection with a different angle, and then is reflected from the second reflecting mirror (M2) 172 and the third reflecting mirror (M3) 173. Since the angle of reflection exceeds the reflection range of the fourth reflecting mirror (M4) 174, therefore the image beam Li′ is eliminated. If the overlapped light beam Li′ passes through the aperture 132 and enters into the image module, the overlapped light beam Li′ will be affected by the angle of incidence of the light on each reflecting mirror and he angle of the reflecting mirror plane, such that the factor of overlapped light beam (FOL) and the diameter d of the aperture are related to the angle of the reflecting mirror plane and the width of the reflecting mirror plane. On the reflecting mirror (M3) 173, the factor of overlapped light beam (FOL) is eliminated. A good effect of eliminating the overlapped light may be obtained, if the condition of Equation (5) may be achieved:

$$\begin{matrix}FOL = \frac{sin ( {α}_{1} ) \cdot sin ( {α}_{2} ) \cdot sin ( {α}_{3} )}{d} \cdot {λ}_{3} \leq \frac{1}{2} ; & ( 5 ) \\ {λ}_{3} = \sqrt{{( {M}_{3 X} - {M}_{5 X} )}^{2} + {( {M}_{3 Z} - {M}_{5 Z} )}^{2}} ; & ( 6 )\end{matrix}$$

wherein, λ₃ is the minimum width of the reflecting mirror (M3) 173, which may be represented by the coordinates of the reflecting point. In other words, (M_{3X}, M_{3Z}) and (M_{5X}, M_{5Z}) on the X-Z plane are coordinates of the reflecting points of twice reflection of the image beam occurred at M3; and FOL is a factor of overlapped light beam (FOL), and d is the diameter of the aperture.

The penta-mirror multi-reflection scanning module in accordance with the present invention changes the direction and path of the image of the scanning document through the five reflecting mirrors and increases the total tracking length; such that the distance between the reflecting mirrors and the total tracking length (TTL) satisfy Equation (1), and the sum of inclined angles between the normal line of a reflecting plane of each reflecting mirror and the +Z-axis satisfy Equation (2). If the total tracking length is changed, it is necessary to adjust the distance between the reflecting mirrors only. In addition, the angle and the distance of the five reflecting mirrors are arranged on the reflecting mirror (M3) 173 that satisfy Equation (5) to prevent the overlapped light beam from entering into the pickup lens to reduce the ghost image phenomenon.

In a first preferred embodiment, an image scanning module of A4 size is provided.

With reference to FIG. 4 for an image scanning module 1 having five reflecting mirrors in accordance with a preferred embodiment of the present invention, the image scanning module 1 comprises a cold cathode fluorescent lamp light source 16, five reflecting mirrors M1(171), M2(172), M3(173), M4(174) and M5(175), a pickup lens 15, an image sensor 14 and a frame 13, and an image scanning module of A4 size is used.

After the light source 16 emits a light, and the light passes through the cover glass 12 and is projected at the scanning document 2 (Obj), an image beam Li incident at the image scanning module 1 is produced. After the image beam Li is reflected from the reflecting mirror M1 and projected to the reflecting mirror M2, the image beam Li is reflected by the reflecting mirror M2 and projected to the reflecting mirror M3, and then reflected by the reflecting mirror M3 and projected to the reflecting mirror M4, and then reflected by the reflecting mirror M4 and projected to the reflecting mirror M3, and then reflected from the reflecting mirror M3 and projected to the reflecting mirror M2, and reflected from the reflecting mirror M2 and projected to the reflecting mirror M5, and then reflected from the reflecting mirror M5 to form an image beam Lo. The image beam Lo is focused by the pickup lens 15 to form an image (Img) at the image sensor 14. The frame 13 is provided for disposing each component of the image scanning module 1. The optical path is Li(Obj)→M1→M2→M3→M4→M3→M2→M5→Lo(Img), and αᵢ is an inclined angle between the normal line of a reflecting plane of each reflecting mirror Mi and the +Z-axis, and the coordinates of a reflecting point of the reflecting mirror Mi on the X-Z plane at that time are (M_{iX}, M_{iZ}).

TABLE 1
Optical Parameters of the First Preferred Embodiment

| Surface | α i (°Deg.) | Di (mm) | (M_{iX}, M_{iZ}) |
|---|---|---|---|
| Obj | | 0 | (0, 0) |
| M1 | 171.2 | 70.60 | (0, 70.60) |
| M2 | 59.2 | 34.96 | (−10.51, 37.26) |
| M3 | 87.2 | 61.15 | (49.65, 26.29) |
| M4 | 72.3 | 17.14 | (33.21, 21.46) |
| M3 | 87.2 | 17.45 | (49.59, 27.46) |
| M2 | 59.4 | 65.80 | (−14.24, 43.45) |
| M5 | 142.5 | 21.04 | (−9.24, 63.89) |
| Img | | 70.60 | (57.832, 63.89) |

In this preferred embodiment, the total number of reflection times p=7, and the total distance between the reflecting mirrors and the total tracking length (TTL) satisfy Equation (1), and the sum of angles of each reflecting mirror along the optical path satisfies Equation (2), and the diameter of an aperture 132 on the frame 13 where the multi-reflection occur at M2 and M3, frame 13 is d=5 mm, and the reflecting mirror (M3) 173 satisfies Equation (5), in order to eliminate the overlapped light and stop the ghost image phenomenon effectively.

$$TTL = {D}_{i} + {D}_{1} + {D}_{2} + {D}_{3} + {D}_{4} + {D}_{5} + {D}_{6} + {D}_{O} = 355.22 mm$$

$$\frac{{D}_{refl}}{2 ( TTL - {D}_{refl} )} = 0.7901$$

$${\sum }_{i = 1}^{7} {α}_{i} - \frac{π}{2} ( 7 + 1 ) = 0.022 \cdot π \leq \frac{π}{( 7 + 1 )}$$

$$FOL = 0.0307$$

In a second preferred embodiment, an image scanning module of A3 size is provided.

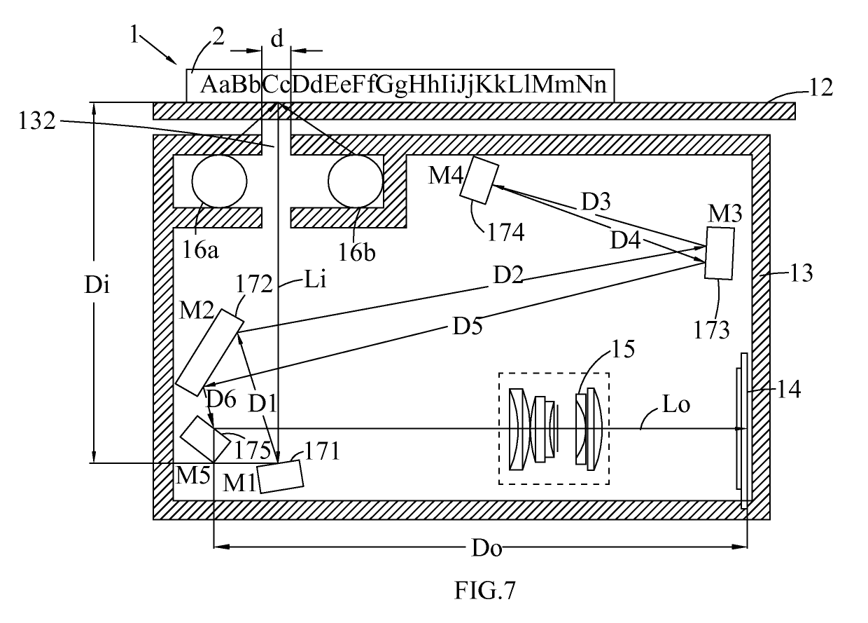

With reference to FIG. 7 for an image scanning module 1 having five reflecting mirrors in accordance with a preferred embodiment of the present invention, the image scanning module 1 comprises two cold cathode fluorescent lamp light sources 16a, 16b, five reflecting mirrors M1(171), M2(172), M3(173), M4(174) and M5(175), a pickup lens 15, an sensor 14 and a frame 13, and the A3 sized image scanning module is used in this preferred embodiment. The total tracking length (TTL) of the A3 sized image scanning module is longer than the total tracking length of the A4 sized image scanning module, and the TTL of this preferred embodiment is 492.98 mm. After the distance between the reflecting mirrors is adjusted without changing the angle of each reflecting mirror, the total tracking length of the A4 sized image scanning module is adjusted to the total tracking length of the A3 sized image scanning module.

The optical path of this preferred embodiment is the same as that of the first preferred embodiment, which is Li(Obj)→M1→M2→M3→M4→M3→M2→M5→Lo(Img), and αᵢ is an inclined angle between the normal line of a reflecting plane of each reflecting mirror Mi and the +Z-axis, and the coordinates of a reflecting point of the reflecting mirror Mi on the X-Z plane at that time are (M_{iX}, M_{iZ}) as shown in Table 2.

TABLE 2
Optical Parameters of the Second Preferred Embodiment

| Surface | α i (°Deg.) | Di (mm) | (M_{iX}, M_{iZ}) |
|---|---|---|---|
| Obj | | 0 | (0, 0) |
| M1 | 171.2 | 70.60 | (0, 70.60) |
| M2 | 59.2 | 27.00 | (−8.09, 44.93) |
| M3 | 87.2 | 93.37 | (83.73, 28.17) |
| M4 | 72.3 | 43.80 | (41.70, 15.82) |
| M3 | 87.2 | 44.59 | (83.57, 31.15) |
| M2 | 59.4 | 101.08 | (−14.63, 55.75) |
| M5 | 142.5 | 8.37 | (−12.64, 63.89) |
| Img | | 104.21 | (91.5655, 63.89) |

In this preferred embodiment, the total number of reflection times p=7, and the total distance between the reflecting mirrors and the total tracking length (TTL) satisfy Equation (1), and the sum of angles of each reflecting mirror along the optical path satisfies Equation (2), and the diameter of an aperture 132 on the frame 13 where the multi-reflection occur at M2 and M3 is d=5 mm, and the reflecting mirror (M3) 173 satisfies Equation (5), in order to eliminate the overlapped light and stop the ghost image phenomenon effectively.

$$TTL = {D}_{i} + {D}_{1} + {D}_{2} + {D}_{3} + {D}_{4} + {D}_{5} + {D}_{6} + {D}_{O} = 492.98 mm$$

$$\frac{{D}_{refl}}{2 ( TTL - {D}_{refl} )} = 0.9101$$

$${\sum }_{i = 1}^{7} {α}_{i} - \frac{π}{2} ( 7 + 1 ) = 0.022 \cdot π \leq \frac{π}{( 7 + 1 )}$$

$$FOL = 0.0783$$

Compared with the first preferred embodiment, this preferred embodiment simply adjusts the distance of the reflecting mirrors without the need of adjusting the angle of the reflecting mirror in order to adjust the TTL of the first preferred embodiment from 355.22 mm to 492.98 mm to broaden the scope of applicability.

In a third preferred embodiment, an image scanning module of A4 size is provided.

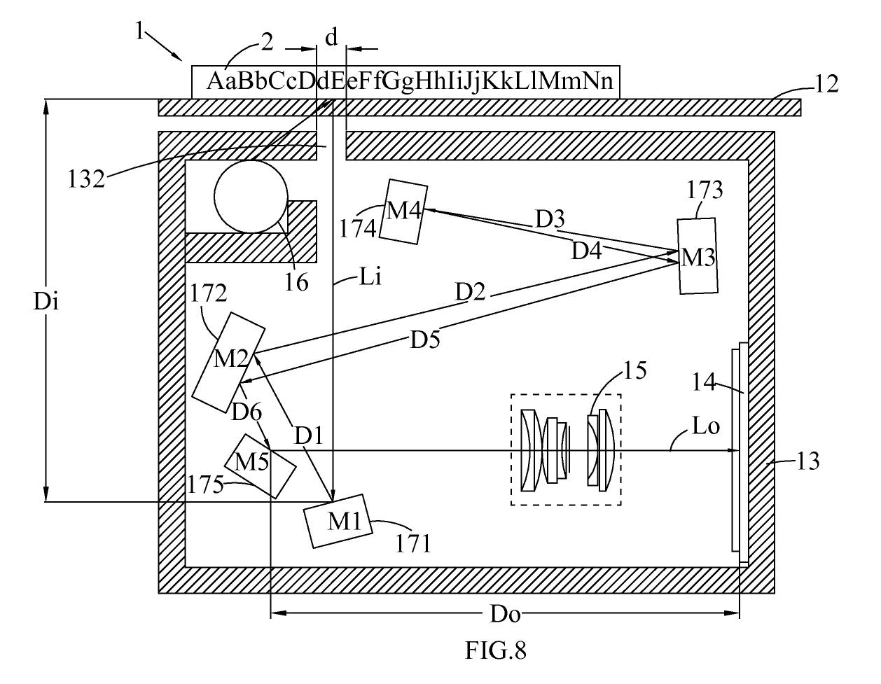

With reference to FIG. 8 for an image scanning module 1 having five reflecting mirrors in accordance with a preferred embodiment of the present invention, the image scanning module 1 comprises a cold cathode fluorescent lamp light source 16, five reflecting mirrors M1(171), M2(172), M3(173), M4(174) and M5(175), a pickup lens 15, an image se and a frame 13, wherein an A4 sized image scanning module is used in this preferred embodiment.

After the light source 16 emits a light, and the light passes through the cover glass 12 and is projected onto scanning document 2(Obj), an image beam Li incident at the image scanning module 1 is produced.

The optical path of this preferred embodiment is the same as those of the first and second preferred embodiments, which is Li(Obj)→M1→M2→M3→M4→M3→M2→M5→Lo(Img), and αᵢ is an inclined angle between the normal line of a reflecting plane of each reflecting mirror Mi and the +Z-axis, and the coordinates of a reflecting point of the reflecting mirror Mi on the X-Z plane at that time are (M_{iX}, M_{iZ}) as shown in Table 3.

TABLE 3
Optical Parameters of the Third Preferred Embodiment

| Surface | α i (°Deg.) | Di (mm) | (M_{iX}, M_{iZ}) |
|---|---|---|---|
| Obj | | 0 | (0, 0) |
| M1 | 165.7 | 58.10 | (0, 58.10) |
| M2 | 65.8 | 23.88 | (−11.04, 36.85) |
| M3 | 87.2 | 60.71 | (47.89, 23.05) |
| M4 | 78.7 | 36.40 | (12.32, 16.97) |
| M3 | 87.9 | 36.08 | (47.93, 24.52) |
| M2 | 65.6 | 63.52 | (−13.26, 41.52) |
| M5 | 121.3 | 10.26 | (−8.84, 50.72) |
| Img | | 66.26 | (57.42, 50.72) |

In this preferred embodiment, the total number of reflection times p=7, and the total distance between the reflecting mirrors and the total tracking length (TTL) satisfy Equation (1), and the sum of angles of each reflecting mirror along the optical path satisfies Equation (2), and the diameter of an aperture 132 on the frame 13 where the multi-reflection occur at M2 and M3 is d=5 mm, and the reflecting mirror (M3) 173 satisfies Equation (5), in order to eliminate the overlapped light and stop the ghost image phenomenon effectively.

$$TTL = {D}_{i} + {D}_{1} + {D}_{2} + {D}_{3} + {D}_{4} + {D}_{5} + {D}_{6} + {D}_{O} = 355.22 mm$$

$$\frac{{D}_{refl}}{2 ( TTL - {D}_{refl} )} = 0.9281 \\ - \frac{π}{( 7 + 1 )} \leq {\sum }_{i = 1}^{7} {α}_{i} - \frac{π}{2} ( 7 + 1 ) = 0.0162 \cdot π$$

$$FOL = 0.2275$$

In a fourth preferred embodiment, an image scanning module of A3 size is provided.

With reference to FIG. 8 for an image scanning module 1 having five reflecting mirrors in accordance with a preferred embodiment of the present invention, the image scanning module 1 comprises a cold cathode fluorescent lamp light source 16, five reflecting mirrors M1(171), M2(172), M3(173), M4(174) and M5(175), a pickup lens 15, an image sensor 14 and a frame 13, wherein an A3 sized image scanning module is used in this preferred embodiment, and the TTL=492.98 mm, and the distance between the reflecting mirrors of the image scanning module of the third preferred embodiment is adjusted without changing the angle of each reflecting mirror, such that the TTL of the A4 sized image scanning module is adjusted to the TTL of the A3 sized image scanning module.

The optical path of this preferred embodiment is the same as that of the third preferred embodiment, which is Li(Obj)→M1→M2→M3→M4→M3→M2→M5→Lo(Img), and αᵢ is an inclined angle between the normal line of a reflecting plane of each reflecting mirror Mi and the +Z-axis, and the coordinates of a reflecting point of the reflecting mirror Mi on the X-Z plane at that time are (M_{iX}, M_{iZ}) as shown in Table 4.

TABLE 4
Optical Parameters of the Fourth Preferred Embodiment

| Surface | α i (°Deg.) | Di (mm) | (M_{iX}, M_{iZ}) |
|---|---|---|---|
| Obj | | 0 | (0, 0) |
| M1 | 166.1 | 58.1 | (0, 58.1) |
| M2 | 65.9 | 36.45 | (−17, 25.86) |
| M3 | 88.2 | 78.45 | (59.12, 6.88) |
| M4 | 78.8 | 21.56 | (37.91, 2.99) |
| M3 | 88.2 | 20.65 | (58.11, 7.28) |
| M2 | 65.9 | 83.34 | (−22.16, 29.69) |
| M5 | 122.4 | 24.56 | (−11.31, 51.73) |
| Img | | 169.86 | (158.55, 51.73) |

In this preferred embodiment, the total number of reflection times p=7, and the total distance between the reflecting mirrors and the total tracking length (TTL) satisfy Equation (1), and the sum of angles of each reflecting mirror along the optical path satisfies Equation (2), and the diameter of an aperture 132 on the frame 13 where the multi-reflection occur at M2 and M3 is d=5 mm, and the reflecting mirror (M3) 173 satisfies Equation (5), in order to eliminate the overlapped light and stop the ghost image phenomenon effectively.

$$TTL = {D}_{i} + {D}_{1} + {D}_{2} + {D}_{3} + {D}_{4} + {D}_{5} + {D}_{6} + {D}_{O} = 492.98 mm$$

$$\frac{{D}_{refl}}{2 ( TTL - {D}_{refl} )} = 0.5751 \\ - \frac{π}{( 7 + 1 )} \leq {\sum }_{i = 1}^{7} {α}_{i} - \frac{π}{2} ( 7 + 1 ) = - 0.0162 \cdot π$$

$$FOL = 0.0475$$

Compared with the third preferred embodiment, this preferred embodiment simply adjusts the distance of the whole set of reflecting mirrors without the need of adjusting the angle of the reflecting mirror in order to adjust the TTL of the first preferred embodiment from 355.22 mm to 492.98 mm to broaden the scope of applicability.

In a fifth preferred embodiment, an image scanning module of small A3 size is provided.

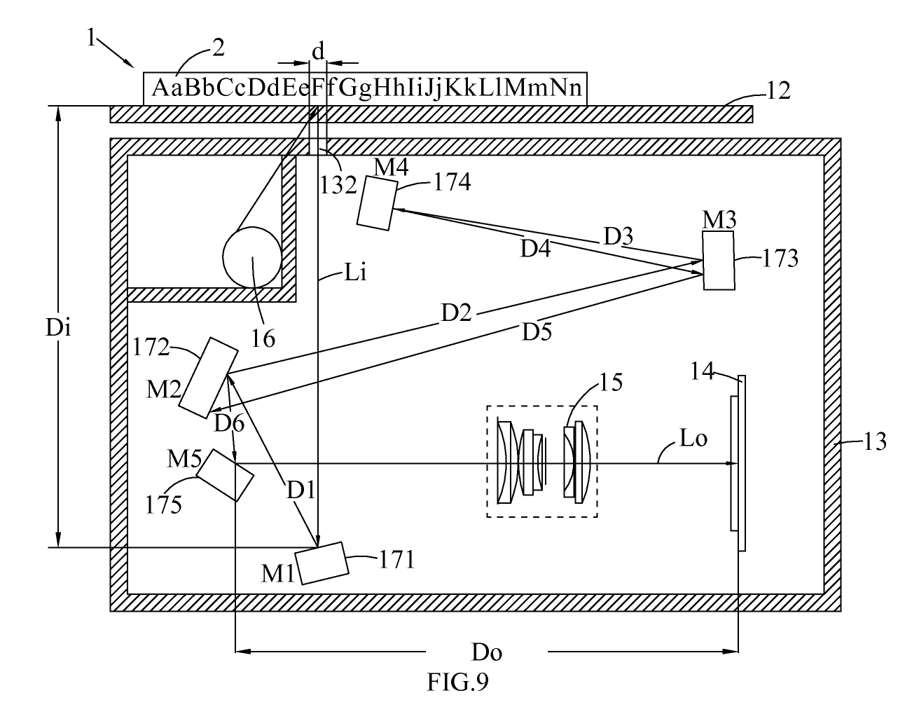

With reference to FIG. 9 for an image scanning module 1 having five reflecting mirrors in accordance with a preferred embodiment of the present invention, the image scanning module 1 comprises a cold cathode fluorescent lamp light source 16, five reflecting mirrors M1(171), M2(172), M3(173), M4(174) and M5(175), a pickup lens 15, an image se and a frame 13, wherein an A3 sized image scanning module is used in this preferred embodiment similar to the fourth preferred embodiment, and the TTL=492.98 mm, and the distance between the reflecting mirrors of the image scanning module of the fourth preferred embodiment is adjusted without changing the angle of each reflecting mirror, such that the volume of the A4 sized image scanning module may be reduced.

The optical path of this preferred embodiment is the same as that of the third preferred embodiment, which is Li(Obj)→M1→M2→M3→M4→M3→M2→M5→Lo(Img), and αᵢ is an inclined angle between the normal line of a reflecting plane of each reflecting mirror Mi and the +Z-axis, and (M_{iX}, M_{iZ}) are coordinates of a reflecting point of a reflecting mirror Mi on the X-Z plane as shown in Table 5:

TABLE 5
Optical Parameters of the Fifth Preferred Embodiment

| Surface | α i (°Deg.) | Di (mm) | (M_{iX}, M_{iZ}) |
|---|---|---|---|
| Obj | | 0 | (0, 0) |
| M1 | 166.1 | 76.61 | (0, 76.61) |
| M2 | 65.9 | 34.15 | (−15.99, 46.44) |
| M3 | 88.2 | 84.89 | (73.15, 23.95) |
| M4 | 78.8 | 55.39 | (12.55, 17.70) |
| M3 | 88.2 | 54.9 | (65.70, 29.20) |
| M2 | 65.9 | 88.93 | (−18.90, 53.00) |
| M5 | 122.4 | 9.67 | (−14.80, 61.70) |
| Img | | 88.46 | (69.56, 61.70) |

In this preferred embodiment, the total number of reflection times p=7, and the total distance between the reflecting mirrors and the total tracking length (TTL) satisfy Equation (1), and the sum of angles of each reflecting mirror along the optical path satisfies Equation (2), and the diameter of an aperture 132 on the frame 13 where the multi-reflection occur at M2 and M3 is d=5 mm, and the reflecting mirror (M3) 173 satisfies Equation (5), in order to eliminate the overlapped light and stop the ghost image phenomenon effectively.

$$TTL = {D}_{i} + {D}_{1} + {D}_{2} + {D}_{3} + {D}_{4} + {D}_{5} + {D}_{6} + {D}_{O} = 492.98 mm$$

$$\frac{{D}_{refl}}{2 ( TTL - {D}_{refl} )} = 0.9933 \\ - \frac{π}{( 7 + 1 )} \leq {\sum }_{i = 1}^{7} {α}_{i} - \frac{π}{2} ( 7 + 1 ) = - 0.0162 \cdot π$$

$$FOL = 0.3711$$

Compared with the fourth preferred embodiment, the frame of this preferred embodiment has a larger thickness and a smaller length, such that users simply need to adjust the distance between the reflecting mirrors to reduce the volume of the image scanner and meet the requirements for a compact design.

In summation of the description above, the penta-mirror multi-reflection scanning module in accordance with the present invention uses at least two of the five reflecting mirrors for multi-reflection to constitute an optical path to increase the length of the optical path and the depth of field, and substantially reduce or eliminate the overlapped light produced by the multi-reflection of the reflecting mirrors, so as to reduce the ghost image phenomenon.

The penta-mirror multi-reflection scanning module in accordance with the present invention simply adjusts the distance of the reflecting mirrors during the manufacturing and assembling processes without the need of adjusting the angle, so that the image scanning module may be used for the A4/A3 sizes and different effective focal lengths of the pickup lenses to provide a broader scope of applicability.

While the invention has been described by means of specific embodiments, numerous modifications and variations could be made thereto by those skilled in the art without departing from the scope and spirit of the invention set forth in the claims.

What is claimed is:

1. A penta-mirror multi-reflection image scanning module, comprising at least one light source, five reflecting mirrors, a pickup lens, an image sensor and a frame; wherein the light source is projecting light onto a scanning document to produce an image beam Li incident at the image scanning module; the five reflecting mirrors are provided for reflecting the image beam Li to form an image beam Lo incident at the pickup lens; the pickup lens is provided for focusing the image beam Lo to the image sensor; the frame is provided for disposing the light source, the five reflecting mirrors, the pickup lens and the image sensor; the image beam Li, the five reflecting mirrors and the image beam Lo constitute an optical path, and at least two of the five reflecting mirrors on the optical path have a multi-reflection for two or more times of reflections and satisfy the optical condition of:
$$- \frac{1}{2} \cdot \frac{π}{( p + 1 )} \leq {\sum }_{i = 1}^{p} {α}_{i} - \frac{π}{2} ( p + 1 ) \leq \frac{1}{2} \cdot \frac{π}{( p + 1 )} ;$$
wherein p is the total number of reflections along the optical path, and αᵢ is an inclined angle between a normal line of a reflecting plane of an i^{th} reflecting mirror along the optical path and a +Z-axis.

2. The penta-mirror multi-reflection image scanning module of claim 1, wherein a total tracking length of the optical path and a total distance between the five reflecting mirrors satisfy the condition of:
$$0.7 \leq \frac{{D}_{refl}}{2 ( TTL - {D}_{refl} )} \leq 1.0 ;$$
wherein TTL is the total tracking length, and D_{refl} is the total distance between the five reflecting mirrors along the optical path.

3. The penta-mirror multi-reflection image scanning module of claim 1, wherein the five reflecting mirrors include a reflecting mirror M1, a reflecting mirror M2, a reflecting mirror M3, a reflecting mirror M4 and a reflecting mirror M5, and the optical path is Li (Obj, scanning document)→M1→M2→M3→M4→M3→M2→M5→Lo (Img, image sensor), and the reflecting mirror M2 and the reflecting mirror M3 undergo multi-reflections, and each having a reflection twice.

4. The penta-mirror multi-reflection image scanning module of claim 1, wherein the light source is selected from the group consisting of a cold cathode fluorescent lamp, a light emitting diode (LED) lamp and a xenon lamp.
